(19) United States
(12) Patent Application Publication
(10) Pub. No.: US 2009/0207770 A1
(43) Pub. Date: Aug. 20, 2009

(54) Apparatus and method for power management of wirelessly networked devices

(76) Inventors: Robert T. Fayfield, Orono, MN (US); Gregory Robert Storms, Chaska, MN (US)

Correspondence Address: CYR & ASSOCIATES, P.A., 605 U.S. Highway 169, Suite 300, Plymouth, MN, 55441, US

(21) Appl. No.: 12/378,436

(22) Filed: Feb. 13, 2009

Related U.S. Application Data
(60) Provisional application No. 61/065,791, filed on Feb. 14, 2008.

(51) Int. Cl. G08C 17/02

(52) U.S. Cl. 370/311

(57) ABSTRACT

A wireless sensor and actuator network includes a number of wireless nodes, each of which may be connected to any one or combination of analog sensors, digital sensors, and actuators, and is powered by an autonomous power supply such as a battery or solar panel. Since autonomous power sources may not have sufficient voltage for powering many types of analog sensors, digital sensors, and actuators, power management techniques are used in the node and in the autonomous power supply as needed to enable effective and long life operation of the node and connected devices. These power management techniques include the use of a low impedance energy reservoir and a variable voltage boost converter whose output voltage magnitude, duration, and operating times are software configurable and controllable. The power management techniques are particularly useful for operating a wide range of different types of sensors and actuators.

### CROSS-REFERENCE TO RELATED APPLICATIONS

This application claims the benefit of U.S. Provisional Patent Application Ser. No. 61/065,791 filed Feb. 14, 2008, which hereby is incorporated herein in its entirety by reference thereto.

### BACKGROUND OF THE INVENTION

1. Field of the Invention

The present invention relates to power management of wirelessly networked devices, and more particularly to power management of wirelessly networked sensors and actuators from nodes supplied by autonomous power sources whose voltage is low relative to the requirements of the sensors and actuators.

2. Description of Related Art

Wireless sensor networks are increasingly desirable. An example of a radio telemetry module suitable for a wireless sensor network is model no. 905U-K available from ELPRO Technologies Pty Ltd. of Stafford, Queensland, Australia. The module is powered from a 6 to 30 VDC supply, with an optional 9 VDC battery pack model no. BU-5 being available. The battery pack uses six AA alkaline batteries. Power consumption is conserved by placing the unit in sleep mode between transmissions. The unit generates a 24 VDC 50 mA supply and is designed for powering only an analog loop.

Unfortunately, many sensors in common use have high power requirements, so that the use of batteries to power wireless nodes that use such sensors can be impractical because of poor battery life. They may also have different voltage requirements.

### BRIEF SUMMARY OF THE INVENTION

These and other disadvantages are overcome individually or in combination by one or more of the embodiments of the invention. Various illustrative embodiments of the invention include the following.

One embodiment of the present invention is a wireless apparatus for controlling a connectable device, comprising an input power terminal for receiving an input voltage; a boost converter coupled to the power terminal for converting the input voltage to an output voltage greater than the input voltage; a controller coupled to the boost converter for establishing the output voltage at a configurable magnitude at a configurable on-time and for a configurable duration; an output terminal coupled to the power converter for providing the output voltage to the connectable device; and a wireless transceiver coupled to the controller.

Another embodiment of the present invention is a wireless apparatus for controlling a device that is operable upon application of an operating voltage for a predetermined duration, comprising: a controller; an autonomous power source connector; a variable voltage boost converter coupled to the autonomous power source connector and controllable by the controller for converting a voltage on the autonomous power source connector to a configurable output voltage greater than the voltage on the autonomous power source connector for a configurable duration; an input circuit coupled to the controller for receiving data in a coordinated manner with the output voltage; and a wireless transceiver coupled to the controller for transmitting the data received at the input circuit. The configurable voltage is settable to the device operating voltage, and the configurable duration is settable to the predetermined duration.

Another embodiment of the present invention is a wireless apparatus for controlling a connectable device, comprising: a lithium-thionyl chloride battery; a low impedance energy reservoir coupled to the lithium-thionyl chloride battery for providing when needed an input voltage at a temporary current in excess of current available from the lithium-thionyl battery; a switch mode power converter coupled to the low impedance energy reservoir for converting the input voltage to an output voltage greater than the input voltage; a controller coupled to the switch mode power converter for establishing the output voltage at a configurable magnitude for a configurable duration; an output terminal coupled to the power converter for providing the output voltage to the connectable device; and a wireless transceiver coupled to the controller.

Another embodiment of the present invention is a method of operating a wireless node for controlling a connectable device, comprising providing an input voltage; converting the input voltage to an output voltage greater than the input voltage; establishing the output voltage at a configurable magnitude for a configurable duration; providing the output voltage to the connectable device; and transmitting information relating to the connectable device using radio frequency energy.

### BRIEF DESCRIPTION OF THE SEVERAL VIEWS OF THE DRAWINGS

FIG. 1 is a schematic block diagram of a wireless sensor network.

FIG. 2 is a schematic block diagram of a node and power source suitable for the wireless sensor network of FIG. 1.

FIG. 3 is a schematic diagram of an illustrative implementation of a low impedance energy reservoir suitable for the power source of FIG. 2.

FIG. 4 is a more detailed schematic block diagram of a node that shows various components of the variable voltage boost converter.

FIG. 5 is a flowchart of a polling loop.

FIG. 6 is a flowchart of another polling loop.

### DETAILED DESCRIPTION OF THE INVENTION, INCLUDING THE BEST MODE

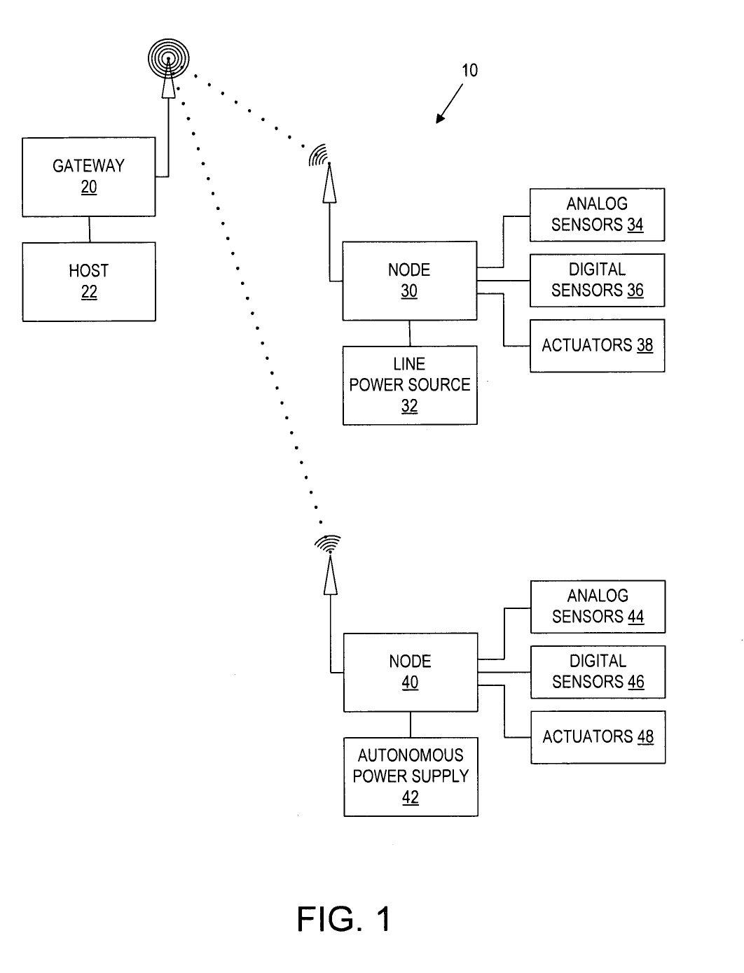

FIG. 1 is a schematic block diagram of a wireless sensor network 10 that provides reliable monitoring without the burden of wiring or conduit installation and can operate independently of or in conjunction with a programmable logic controller and/or a personal computer. The wireless sensor network 10 is useful in a wide variety of challenging applications, including monitoring fluid levels in storage vessels; monitoring and data acquisition on rotating machinery; remote monitoring of towers or tank farms; manufacturing monitoring and error proofing; notification of power outages or system status emergencies; triggering backup power systems when needed; monitoring end effectors or robotic arms; barn or dairy bulk tank temperature monitoring; security monitoring and control of remote location; and refrigerated storage system temperature monitoring.

The wireless network system 10 illustratively includes a master unit which may be referred to as a gateway 20, which initiates communication and reporting with any number of nodes such as illustrative nodes 30 and 40. The gateway 20, which acts as the master device within the wireless sensor network 10, may be controlled by any suitable type of host 22, which includes personal computers and programmable logic controllers. Each of the nodes in the wireless sensor network 10 may be connected to one or more devices such as analog sensors, discrete (digital) sensors, and actuators, and reports sensor and status data to the gateway 20, which communicates the information to the host 22 for processing. Illustratively, node 30 may be connected to any one or combination of analog sensors 34, digital sensors 36, and actuators 38, and is powered by a line power source 32 such as a DC line which provides illustratively from 10 VDC to 30 VDC. Such voltage levels are sufficient for powering many types of analog sensors, digital sensors, and actuators.

Illustratively, node 40 may be connected to any one or combination of analog sensors 44, digital sensors 46, and actuators 48, and is powered by an autonomous power supply 42 such as a battery or solar panel. Since autonomous power sources may not have sufficient voltage for powering many types of analog sensors, digital sensors, and actuators, advantageously various power management techniques are used in the node 40 and in the autonomous power supply 42 as needed to enable effective and long life operation of the node 40 and connected devices 44, 46 and 48. These power management techniques include the use of a low impedance energy reservoir and a voltage boost converter whose output voltage magnitude, on-time, and operating times are software configurable and controllable in real time. A user may, for example, program a suitable polling loop that meets the users requirements for minimum desired on-time, minimum desired operating times, and desired battery life, based on the technical specifications for the connected sensors.

The power management techniques are particularly useful for operating a wide range of different types of commercially available sensors and actuators, including sensors that support the HART protocol, thereby enabling much of the large existing installed base of wired sensor and actuator networks to go wireless. Because commercially available sensors span such a wide range of voltage, current and start up/settling time specifications, the minimum supply parameters required to power one sensor are often significantly different from those required to supply another. For example, a digital optical tank level switch sensor may require 6V at 10 mA for 20 ms to generate a valid switching output determination, whereas an analog ultrasonic tank level sensor may require 18V at 100 mA for 1000 ms to provide a stable analog output level. The total energy required to make an analog ultrasonic tank level measurement is about 1500 times greater than the energy required to read the status of the level switch. The power management techniques described herein provide the appropriate voltage, current and start up/settling time for each type of sensor.

Furthermore, different types of sensors may be simultaneously connected to the same battery powered wireless sensor node in a practical monitoring or control system. In the above example, the lower power optical level switch may be used to roughly measure the level of milk in a storage tank, while the high power ultrasonic sensor may be used to precisely measure the level of milk. Because of its low power consumption, measurements may be taken frequently with the optical level switch. However, the more accurate ultrasonic sensor should be used sparingly. A polling loop may be used to take frequent measurements with the optical level switch and infrequent measurements with the ultrasonic sensor. Alternatively, under host control, measurements may be taken with the ultrasonic sensor when the milk level decreases below a predetermined set point and a more accurate level measurement is needed, and when the level as measured by the ultrasonic sensor reaches a second predetermined set point, an actuator may be operated to take a desired action. An actuator may be operated to flash an alert light, sound an alarm, or to open a valve that refills the milk storage tank until the optical level switch indicates that the tank is full.

The autonomous power supply 42 may be any type of autonomous power supply, including solar panel and battery. While alkaline and other types of batteries may be used, a particularly advantageous type of battery is a lithium-thionyl chloride primary battery. The lithium-thionyl chloride cell has a liquid mixture of thionyl chloride and lithium tetrachloroaluminate that act as the cathode and electrolyte respectively. A porous carbon material serves as a anode current collector which receives electrons from the external circuit. The lithium-thionyl chloride cell is particularly advantageous for use in wireless remote monitoring because of its long life and large energy density, illustratively about 500 watt-hour/kilogram. Moreover, the lithium-thionyl chloride cell is suitable for low temperature applications, in which it can operate down to about −55° C. where it retains over 50% of its rated capacity.

Unfortunately, the lithium-thionyl chloride cell has some disadvantages which limit its usefulness in some remote monitoring applications. Due to their high internal impedance, the cells are best suited to extremely low-current applications and would not be suitable inherently for powering sensors that require high current to operate. Higher current lithium-thionyl chloride cells are available at higher cost, but even these may be unsuitable for powering some types of sensors. These disadvantages may be overcome by using a low impedance energy reservoir with the lithium-thionyl chloride battery.

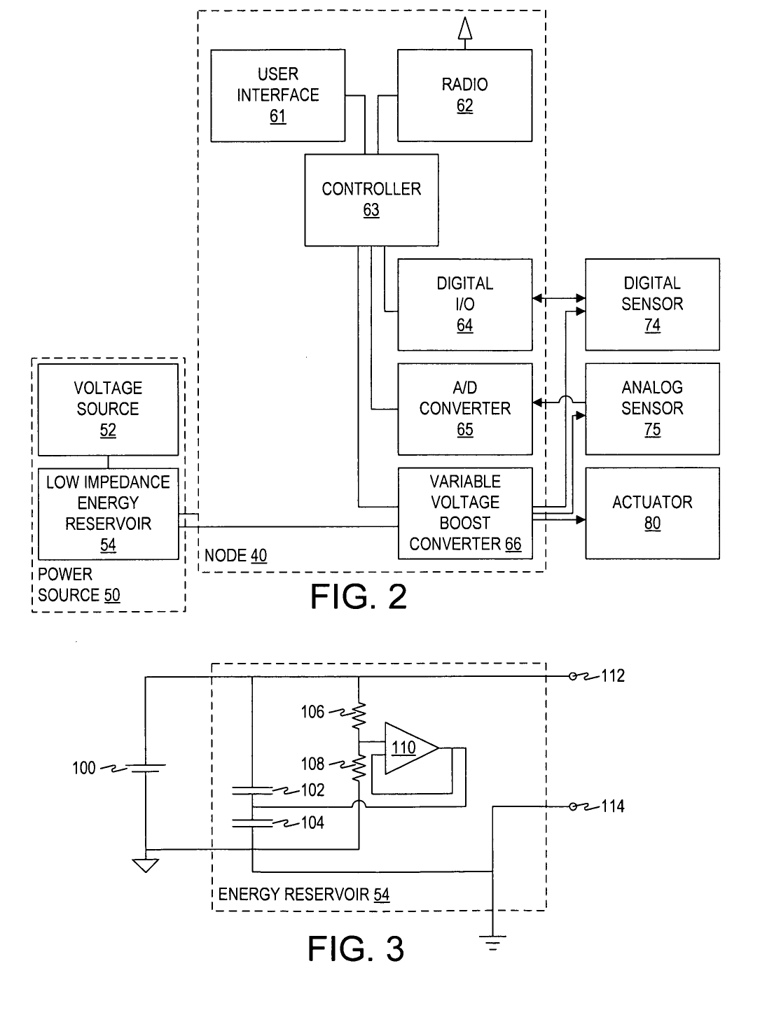

FIG. 2 is a schematic block diagram showing the node 40 in greater detail, along with an illustrative autonomous power source 50 that uses a voltage source 52 whose intrinsic voltage and current output may be insufficient to power one or more of devices 74, 75 and 80 connected to the node 40. A controller 63 is accessible by a user and communicates information to the user and receives information and instructions from the user via any suitable user interface 61, and controls the operation of a radio transceiver 62 for wirelessly communicating information with the gateway. The controller 63 may control the operation of one or more digital (i.e. discrete) sensors such as digital sensor 74 by suitably configuring and enabling a variable voltage boost converter 66 to power the sensor 74 and receive data from and possibly provide data to the sensor 74 through a digital input/output circuit 64. The controller 63 may also control the operation of one or more analog sensors such as analog sensor 75 by suitably configuring and enabling the variable voltage boost converter 66 to power the sensor 75 and monitoring the output of sensor 75 through an analog-to-digital converter 65. The controller 63 may also control the operation of one or more actuators such as actuator 80 by suitably configuring and enabling the variable voltage boost converter 66 to power the actuator 80. Suitable actuators include valves, servos, annunciators, and lights such as the EZ-Light™ indicator lights available from Banner Engineering Inc. of Minneapolis, Minn., USA. Actuators may or may not have outputs to communicate their state and other useful information.

Since the intrinsic current output of the voltage source 52 may be inadequate for powering the sensors 74 and 75 and the actuator 80, the power source 50 includes a low impedance energy reservoir 54 to compensate for any inadequacy. The variable voltage boost converter 66 in the node 40 compensates for any inadequacy in the voltage output of the voltage source 52. The under voltage source 52 may be, for example, a lithium-thionyl chloride battery.

The various components of the node 40 and the power source 50 may be housed in any desired manner. Illustratively, the components of node 40 may be housed in one waterproof housing while the components of the power source 50 may be housed in a separate waterproof housing. Waterproof cabling and connectors may be used to interconnect the components in the separate housings, as well as to connect the sensors 74 and 75 and the actuator 80 to the node 40. Alternatively, the components of the node 40 and the power source 50 may be housed together in one housing, or the components of the node 40 and the components of the low impedance energy reservoir 54 may be housed together in one housing while the voltage source 52 may be housed in a separate housing.

FIG. 3 is a schematic diagram of an illustrative implementation of the low impedance energy reservoir 54 as used with a lithium-thionyl chloride battery 100. A series capacitive circuit of two or more super capacitors 102 and 104 is connected across the anode and cathode of the lithium-thionyl chloride battery 100, to provide charge storage that is useful for supplying higher temporary currents at the outputs 112 and 114. A series resistive circuit of two or more resistors 106 and 108 also is connected across the anode and cathode of the lithium-thionyl chloride battery 100. An active balancing circuit, illustratively an operational amplifier 110 with feedback, has its free input connected between the resistors 106 and 108, and its output connected between the capacitors 102 and 104 to balance the charge on the series-connected super capacitors 102 and 104. Illustrative suitable values for the various components of the low impedance energy reservoir 54 are as follows: the battery 100 is 3.6V, each of the capacitors 102 and 104 is 0.5 f, each of the resistors 106 and 108 is 500 kΩ, and the operational amplifier 110 is any ultra low quiescent current device.

In operation, the circuit of FIG. 3 supplies a higher temporary current than the lithium thionyl chloride battery 100 alone could supply. In the milk storage tank example, a typical ultrasonic sensor operating at 12 VDC might require 500 mA to be supplied from the battery for about 500 ms while the sensor output stabilizes. This amount of current cannot be supplied directly from a lithium thionyl chloride primary battery, but can be supplied temporarily from the low impedance energy reservoir 54.

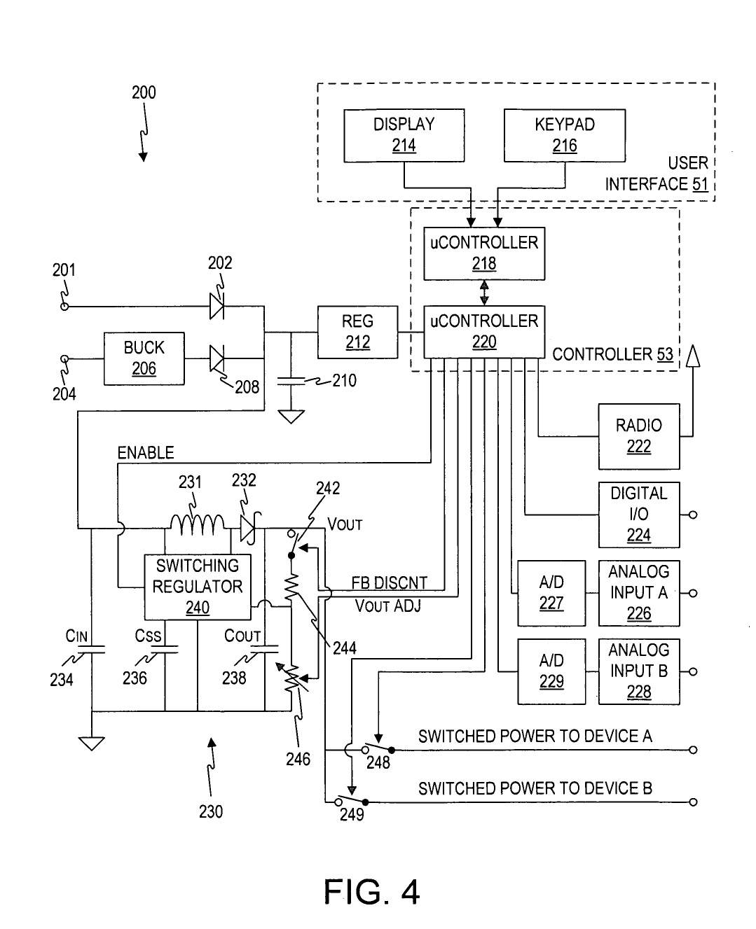

FIG. 4 is a detailed schematic block diagram of an illustrative implementation 200 of the node 40 of FIG. 2. A voltage input circuit accepts a voltage input of illustratively from 3.6 VDC to 5.5 VDC on connector 201, and a voltage input of from 10 VDC to 30 VDC on connector 204. Connector 201 may be provided for connection to an autonomous power supply, for example, while connector 204 may be provided for connection to a line source, for example. Diodes 202 and 208 are blocking diodes to prevent reverse current flow. The diode 202 preferably implements a near ideal diode function, and may be realized using a type LT®C4412 controller, which is available from Linear Technology Corporation of Milpitas, Calif., USA, with an external P-channel MOSFET. A buck circuit 206 pulls down the voltage on the connector 204 to a value suitable for the other circuits in the node 200, illustratively about 5.5V. The input power is filtered by capacitor 210 and applied to many of the various circuits of the node 200 through a voltage regulator 212, illustratively a 3 volt voltage regulator. Illustratively, the controller 53 is implemented by two microcontrollers 218 and 220. Microcontroller 218 controls input and output for a user interface that illustratively includes a display 214 and a keypad 216. Microcontroller 220 controls input and output functions of a radio 222; digital I/O ports 224; analog input 226 which receives an analog signal, if any, from a connected device “A” and converts the analog signal to digital data in the A/D converter 227; switch 248 which controls application of power (illustratively up to 24 VDC) to the connected device “A,” analog input 228 which receives an analog signal, if any, from a connected device “B” and converts the analog signal to digital data in the A/D converter 229; and switch 249 which controls application of power (illustratively up to 24 VDC) to the connected device “B.”

Circuit 230 is an illustrative implementation of a variable voltage boost converter that provides a output voltage V_{OUT} to switches 248 and 249, where the magnitude, on-time, and start times of V_{OUT} are all variable and controllable. The variable voltage boost converter 230 includes a switching regulator 240, illustratively a type LT® 3467 switch available from Linear Technology Corporation of Milpitas, Calif., USA, to step up the input voltage. Preferably the switching regulator 240 includes a soft-start function. Illustratively, the input voltage, which may be as low as about 3.6 VDC, is stepped up to about 24 VDC. Illustrative values for the various components used by the switching regulator 240 are 4.7 μH for the inductor 231, a low loss Schottky diode for the diode 232, a 10 μF capacitor for the input capacitor 234, a 0.022 μF capacitor for the soft-start capacitor 236, and a 4.7 μF capacitor for the output capacitor 238. Voltage feedback is provided by a resistor 244, illustratively 150 KΩ, connected in series with an electronically variable resistor 246, illustratively 50 KΩ. The resistors 244 and 246 are connected between V_{OUT} and ground, and their junction is connected to the feedback input of the switching regular 240. An electronically controllable switch 242 is connected in the series resistor circuit between the feedback connection and the connection to V_{OUT}. The controller 220 controls the switching regulator 240 using an Enable Signal applied to the SHDN\ input, a feedback disconnect signal FB DISCNT applied to a switch 242, and a V_{OUT} Adjust Signal applied to the electronically variable resistor 246.

It is desirable to eliminate or limit inrush currents within the variable voltage boost converter 66, since they can cause large voltage transients which affect the operation of various components in the node. Voltage transients unnecessarily dissipate power, and can cause the microcontrollers 220 and 218 to brown out and reset, for example. Inrush currents within the variable voltage boost converter 66 may be limited by (a) using the soft start functionality with the switching regulator 240 when the switching regulator 240 is enabled and electrically connected to an attached sensor; and (b) keeping the input power continuously connected to the variable voltage boost converter 66. It is also desirable to eliminate or limit unnecessary quiescent currents within the variable voltage boost converter 66, since such currents unnecessarily dissipate power. This may be achieved by electronically disconnecting the feedback circuit from the switching regulator 240 when the switching regulator 240 is not enabled.

Advantageously, the input capacitor 234 for the switching regulator 240 remains connected to the input voltage and fully charged, even when the switching regulator 240 is disabled. If the input capacitor 234 were disconnected from the input voltage when the switching regulator 240 is disabled, it would have to be recharged by transient currents when the switching regulator 240 is enabled, thereby unnecessarily dissipating power in accordance with the relationship I=CdV/dt.

Advantageously, the feedback circuit for the switching regulator 240 is electronically disconnected when the switching regulator 240 is disabled by non-assertion of the Enable Signal. This may be done by assertion of the feedback disconnect signal FB DISCNT, which opens the switch 242; and/or assertion of a signal on V_{OUT} ADJ which puts the variable resistor 246 in a high impedance state. If the feedback circuit were not disconnected, current would flow from V_{OUT}, which would be approximately equal to the input voltage, through the resistors 244 and 246, and through the resistor 244 and the impedance of the feedback input to the boost circuit 240, unnecessarily dissipating power.

Advantageously, disconnection of the feedback circuit along with opening of the switches 248 and 249 also retards discharge of the output capacitor 238 between active periods, thereby maintaining the output capacitor 238 in at least a partially charged condition to reduce transient currents. If the feedback circuit were not disconnected and if one or more of the external devices were to remain connected to V_{OUT} through switches 248 and 249, the output capacitor 238 would discharge down to the input voltage less the forward voltage drop across the diode 232, or approximately the input voltage. Upon enablement of the switching regulator 240, V_{OUT} would become substantially larger than the input voltage, thereby causing a transient current and unnecessarily dissipating power in accordance with the relationship I=CdV/dt.

Advantageously, the value of the output capacitance 238 may be decreased and the value of the input capacitance 234 increased, relative to one another. Reducing the output capacitance 238 further helps to limit transient currents. To the extent that the output capacitor 238 discharges when the switching regulator 240 is disabled, a current transient in accordance with the relationship I=CdV/dt occurs when the switching regulator 240 is enabled. However, the current transient is reduced proportional to the reduction in the value of the output capacitance 238.

The variable voltage boost converter 66 is useful in a battery powered wireless sensor node to transform low battery voltage to a higher working voltage needed to power a sensor that is connected to the node. However, as the boosted working voltage is increased, the power drain from the battery needed to supply the required current at the required voltage to the sensor also increases. Therefore, to maximize battery life in such a system, the variable voltage boost converter 66 should provide the minimum necessary voltage required to power the sensor for the minimum amount of time required for the sensor to stabilize.

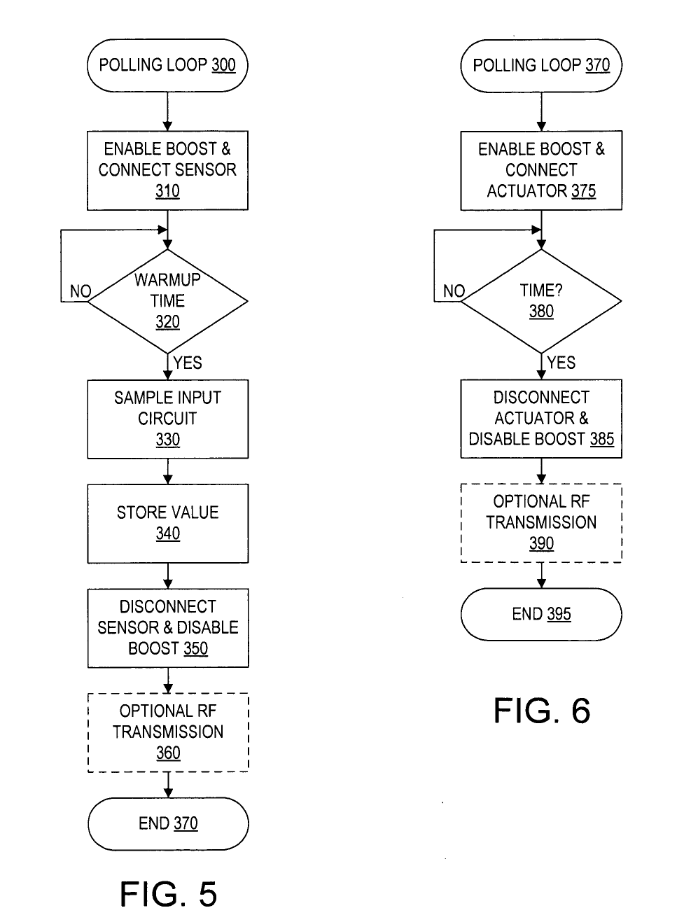

FIG. 5 is a flowchart of an illustrative polling loop 300 that may be executed by the microcontroller 220 periodically or on demand so that each sensor connected to the node may be powered at its particular minimum necessary voltage, for its particular minimum amount of time, and for its particular duty cycle. When the polling loop 300 is called, the boost is enabled, a first sensor is connected, and V_{OUT} is set at V1 for the particular type of sensor selected (block 310). The first sensor remains powered at voltage V1 for a time T1 (block 320 NO), after which (block 320 YES) the input circuit connected to the first sensor is sampled (block 330) and the sampled value is stored in memory (block 340), either temporarily or permanently. The first sensor is disconnected and the boost is disabled (block 350). Optionally the sampled value may be sent over the radio to the gateway (block 360). The process may be called again, either periodically or on demand, and repeated for a second sensor and subsequent sensors. When the process is called for a second sensor, the boost is enabled, the second sensor is connected, and V_{OUT} is set at V2 for the particular type of sensor selected (block 310). The second sensor remains powered at voltage V2 for a time T2 (block 320 NO), after which (block 320 YES) the input circuit connected to the second sensor is sampled (block 330) and the sampled value is stored in memory (block 340), either temporarily or permanently. The second sensor is disconnected and the boost is disabled (block 350). Optionally the sampled value may be sent over the radio to the gateway (block 360).

FIG. 6 is a flowchart of an illustrative polling loop 370 that may be executed by the microcontroller 220 periodically or on demand so that each actuator connected to the node may be powered at its particular minimum necessary voltage, for its particular minimum amount of time, and for its particular duty cycle. When the polling loop 370 is called, the boost is enabled, an actuator is connected, and V_{OUT} is set for the particular type of actuator selected (block 375). The actuator remains powered at it particular voltage for a predetermined time (block 380 NO), after which (block 380 YES) the actuator is disconnected and the boost is disabled (block 385).

The description of the invention including its applications and advantages as set forth herein is illustrative and is not intended to limit the scope of the invention, which is set forth in the claims. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein, including of the alternatives and equivalents of the various elements of the embodiments, may be made without departing from the scope and spirit of the invention.

1. A wireless apparatus for controlling a connectable device, comprising:
an input power terminal for receiving an input voltage;
a boost converter coupled to the power terminal for converting the input voltage to an output voltage greater than the input voltage;
a controller coupled to the boost converter for establishing the output voltage at a configurable magnitude at a configurable on-time and for a configurable duration;
an output terminal coupled to the power converter for providing the output voltage to the connectable device; and
a wireless transceiver coupled to the controller.

2. The wireless apparatus of claim 1 further comprising an input circuit for receiving data from the connectable device, the controller being coupled to the input circuit for acquiring data from the connectable device in a coordinated manner with the output voltage, and wirelessly transmitting the data via the wireless transceiver.

3. The wireless apparatus of claim 1 wherein the boost converter comprises:
a switching regulator having an input for receiving the input voltage and an output for supplying the output voltage, the switching regulator being controllably enabled and disabled by the controller; and
a feedback circuit comprising an electronically variable resistance coupled across the output of the switching regulator and coupled to a feedback input of the switching regulator, the electronically variable resistance being controllably adjustable by the controller.

4. The wireless apparatus of claim 3 wherein the feedback circuit is controllably disconnectable from the switching regulator.

5. The wireless apparatus of claim 4 wherein the boost converter further comprises:
an input capacitor coupled across the input of the switching regulator; and
an output capacitor coupled across the output of the switching regulator;
wherein the input capacitor is continuously coupled to the input power terminal for continuously receiving the input voltage; and
wherein capacitance across the input of the switching regulator is greater than capacitance across the output of the switching regulator.

6. A wireless apparatus for controlling a device that is operable upon application of an operating voltage for a predetermined duration, comprising:
a controller;
an autonomous power source connector;
a variable voltage boost converter coupled to the autonomous power source connector and controllable by the controller for converting a voltage on the autonomous power source connector to a configurable output voltage greater than the voltage on the autonomous power source connector for a configurable duration;
an input circuit coupled to the controller for receiving data in a coordinated manner with the output voltage; and
a wireless transceiver coupled to the controller for transmitting the data received at the input circuit;
wherein the configurable voltage is settable to the device operating voltage, and the configurable duration is settable to the predetermined duration.

7. The wireless apparatus of claim 6 further comprising stored program instructions executable by the controller for periodically enabling the variable voltage boost converter at the configurable voltage for the configurable duration for a first time, and disabling the variable voltage boost converter for a second time.

8. The wireless apparatus of claim 6 further comprising a switch coupled to the variable voltage boost converter and having a plurality of output power connectors for providing the output voltage to respective devices, wherein the configurable output voltage and configurable duration are configurable for each of the devices.

9. The wireless apparatus of claim 8 wherein the input circuit comprises a plurality of data inputs respectively coupled to the devices, for receiving data in a coordinated manner with the output voltage to the respective devices.

10. The wireless apparatus of claim 6 further comprising an autonomous power source comprising:
a lithium primary battery; and
an energy reservoir coupled to the lithium primary battery.

11. The wireless apparatus of claim 10 wherein the energy reservoir is a low impedance energy reservoir comprising a super capacitor coupled to the lithium primary battery.

12. The wireless apparatus of claim 6 wherein the autonomous power source connector is constantly coupled to the input of the variable voltage boost converter, further comprising:
a feedback circuit for controlling the variable voltage boost converter, and
means for electrically disconnecting the feedback circuit when the variable voltage boost converter is disabled.

13. A wireless apparatus for controlling a connectable device, comprising:
a lithium-thionyl chloride battery;
a low impedance energy reservoir coupled to the lithium-thionyl chloride battery for providing when needed an input voltage at a temporary current in excess of current available from the lithium-thionyl battery;
a switch mode power converter coupled to the low impedance energy reservoir for converting the input voltage to an output voltage greater than the input voltage;
a controller coupled to the switch mode power converter for establishing the output voltage at a configurable magnitude for a configurable duration;
an output terminal coupled to the power converter for providing the output voltage to the connectable device; and
a wireless transceiver coupled to the controller.

14. The wireless apparatus of claim 13, wherein the switch mode power converter comprises:
a switching regulator having an input for receiving the input voltage and an output for supplying the output voltage, the switching regulator being controllably enabled and disabled by the controller;
a resistive feedback circuit coupled across the output of the switching regulator and coupled to a feedback input of the switching regulator, the resistive feedback circuit comprising an electronically variable resistor controllably adjustable by the controller for setting the output voltage, the resistive feedback circuit being controllably disconnectable from the switching regulator;
an input capacitor coupled across the input of the switching regulator; and
an output capacitor coupled across the output of the switching regulator;
wherein the input capacitor is continuously coupled to the input power terminal for continuously receiving the input voltage; and
wherein capacitance across the input of the switching regulator is greater than capacitance across the output of the switching regulator.

15. A method of operating a wireless node for controlling a connectable device, comprising:
providing an input voltage;
converting the input voltage to an output voltage greater than the input voltage;
establishing the output voltage at a configurable magnitude for a configurable duration;
providing the output voltage to the connectable device; and
transmitting information relating to the connectable device using radio frequency energy.
